(19) United States
(12) Patent Application Publication
(10) Pub. No.: US 2023/0412122 A1
(43) Pub. Date: Dec. 21, 2023

(54) SYSTEMS, METHODS, AND DEVICES TO CONNECT AN ELECTRICAL POWER SOURCE TO AN ELECTRICAL POWER GRID INSTALLATION

(71) Applicant: WeDoSolar GmbH, Berlin (DE)

(72) Inventor: Qian Qin, Berlin (DE)

(21) Appl. No.: 17/843,822

(22) Filed: Jun. 17, 2022

(51) Int. Cl. H02S 40/34; H01R 43/26; H01R 13/629

(52) U.S. Cl. CPC H02S 40/34; H01R 43/26; H01R 13/62927; H02G 3/30

(57) ABSTRACT

Various implementations of systems, devices, and methods to connect an electrical power source safely to an electrical end user household mains grid installation. In an exemplary implementation, a solar energy module is connected to a typical mains power outlet wall socket using a mains power plug. Potentially live male-shaped connectors of the mains power plug are, for example, isolated and/or disconnected from the electrical power source so that the male-shaped connectors of the unplugged mains power plug are safe for users and bystanders even if the power source produces electrical energy and, therefore, the mains power plug is at least partially live.

### BACKGROUND

### 1. Field

The present inventive concept relates generally to the field of renewable energy and more specifically to systems, methods, and devices to connect an electrical power source to an electrical power grid installation.

### 2. Discussion of Related Art

Energy conversion of sunlight into electricity using photovoltaics, where photovoltaic cells convert light into an electric current using the photovoltaic effect, is a key element of low-carbon strategies in modern societies. To decouple the availability of sunlight from the profile of local power consumption, the solar power generators are recommended to be grid-connected. The electrical grid is a connectivity network distributing electrical energy from producers to consumers.

Private households may place decentralized solar power units on their roof or balcony, but to connect the solar generators to the electrical end user household power grid requires an installation by an electrician, which poses a technical and economic problem.

While typical mains AC power outlet sockets, e.g., wall sockets are readily available, these are designed and typically used to connect electrical household devices consuming electrical energy, acting as electrical loads or energy sinks. The use of AC power plugs with male connectors to connect an energy source or generator to the mains grid of a household poses a safety risk, as an unplugged male connector may become live, e.g., under voltage when the solar power generator is switched on and the sunlight shines on the photovoltaic cells.

It is with these observations in mind, among others, that various aspects of the present inventive concept were conceived and developed.

### SUMMARY

System, methods, and devices presented herein address the foregoing problems by integrating an additional safety mechanism into AC power plugs that connect decentralized renewable energy sources to the electrical mains power grid installations.

For instance, a system to generate and distribute renewable energy, the system can comprise: a power inverter assembled and wired to generate an alternating current energy; an electronic control unit assembled, wired and programmed to control the power inverter to drive the alternating current energy into an electrical grid; and a power plug shaped to conform to a mains power socket; the power plug is connected to the power inverter; the power plug can include: at least one male-shaped connector conforming to at least one corresponding female-shaped connector of the mains power socket; a housing; and at least one contact wired to connect the power plug to the power inverter; wherein the power plug can comprise a safety mechanism assembled, shaped and/or wired to protect a user or a bystander from a hazardous live contact with the at least one male-shaped connector when the system is in operation and the power plug is unplugged.

In some instances, the system can further comprise: one or more solar panels connected to the power inverter; wherein the power inverter can be an electronic power inverter that changes direct current energy received from the one or more solar panels into the alternating current energy; and the mains power socket can be a wall power socket connected to a mains power installation of a residence, or a business connected to the electrical grid. In some scenarios the mains power socket and the power plug conform to one or more national, supranational, or international standards.

In some examples the safety mechanism can include an electromechanical switch assembled, shaped and wired to disconnect the at least one male-shaped connector from a corresponding contact of the at least one contact when the power plug is unplugged.

Moreover, in some examples the safety mechanism can further include a tactile assembly having multiple parts, each shaped and together assembled and geometrically arranged to detect if the power plug is unplugged.

Furthermore, in some examples the tactile assembly can include: at least two tactile parts, each tactile part of the at least two tactile parts having a longitudinal extension and a longitudinal axis, each tactile part is pushed outwards of the housing mainly in the direction of its longitudinal axis by a spring, the longitudinal axis is geometrically positioned in relation to a base of the housing of the power plug mainly in line with the direction of the insertion path of the power plug into the mains power socket so that the at least two tactile parts are pushed into the housing of the power plug when the power plug is operationally positioned in the mains power socket to thereby operating the electromechanical switch to close an electrical connection between the at least one male-shaped connector with a corresponding contact of the at least one contact; and a movable locking element assembled, shaped and geometrically arranged to prevent that only one tactile part of at least two tactile parts can be pushed into the housing of the power plug so that the electromechanical switch is only operated to close when the at least two tactile parts are simultaneously pushed into the housing of the power plug.

In some scenarios, at least one on the at least one tactile part is a pin. Furthermore, in some scenarios at least one tactile part of the at least one tactile part is an isolation sheath covering a corresponding male-shaped connector of the at least one male-shaped connector.

In some instances, the safety mechanism can include a tactile assembly having multiple parts, each shaped and together assembled and geometrically arranged to detect if the power plug is unplugged; wherein the tactile assembly can include: at least one tactile isolation sheaths, each tactile isolation sheath of the at least one tactile isolation sheaths having a longitudinal extension and a first longitudinal axis, each tactile isolation sheath is pushed outwards of the housing mainly in the direction of its first longitudinal axis by a spring, the first longitudinal axis is geometrically positioned mainly in line to a second longitudinal axis of a corresponding male-shaped connector of the at least one male-shaped connector so that the at least one tactile isolation sheath are pushed into the housing of the power plug when the power plug is operationally positioned in the mains power socket to thereby uncovering and operationally deploy the at least one male-shaped connector.

In some examples the tactile assembly further can include: a movable locking element assembled, shaped and geometrically arranged to prevent that only one tactile isolation sheath of the at least one tactile isolation sheaths can be pushed into the housing of the power plug so that the at least one male-shaped connectors are only uncovered and operationally deployed when the at least one tactile isolation sheaths are simultaneously pushed into the housing of the power plug. Furthermore, in some examples the safety mechanism is user-operated requiring a key.

In some scenarios, the safety mechanism can include a user-operated locking mechanism having multiple parts, each shaped and together assembled and geometrically arranged to lock the power plug in the mains power socket. Furthermore, in some scenarios the safety mechanism can further include an electromechanical switch assembled, shaped and wired to disconnect or connect the at least one male-shaped connector from or with a corresponding contact of the at least one contact; wherein the user-operated locking mechanism is further shaped and arranged to operate the electromechanical switch so that an electrical connection between a male-shaped connector of the at least one male-shaped connectors with a corresponding contact of the at least one contacts is closed when the locking mechanism is activated by a user.

In some instances, the safety mechanism can further include a tactile assembly having multiple parts, each shaped and together assembled and geometrically arranged to detect if the power plug is unplugged; the tactile assembly being further shaped and arranged to block the user-operated locking mechanism when the power plug is unplugged.

Moreover, in some instances, the at least one male-shaped connector is retraced and at least partially concealed inside the housing when the power plug is deactivated; the at least one male-shaped connector is forwarded and thereby operationally deployed when the power plug is activated; and wherein the safety mechanism can include a user-operated forwarding mechanism assembled, shaped and geometrically arranged to deploy or to retract the at least one male-shaped connectors to thereby activate or deactivate the power plug.

In some examples, a power plug can comprise: at least one male-shaped connector conforming to at least one corresponding female-shaped connector of a mains power socket; a housing; and at least one contact wired to connect the power plug to an electrical alternating current energy generator; wherein the power plug can comprise a safety mechanism assembled, shaped and/or wired to protect a user or a bystander from a hazardous live contact with a male-shaped connector of the at least one male-shaped connector when the electrical alternating current energy generator is in operation and the power plug is unplugged.

In some instances, a safeguard method to protect a user or a bystander from an electrical hazard can comprise: inserting a power plug into a corresponding mains power socket, the power plug being connected to an electrical alternating current energy generator, the mains power socket being connected to a mains power installation of a residence, or a business connected to an electrical grid; and operating a safety mechanism assembled, shaped and/or wired to protect the user or the bystander from a hazardous live contact with a male-shaped connector of the power plug when the electrical alternating current energy generator is in operation and the power plug is unplugged.

Furthermore, in some instances, the method step of operating the safety mechanism is correlated with the method step of a user inserting the power plug. Moreover, in some instances the method step of operating the safety mechanism is correlated with an activation of a user-operated locking mechanism, the locking mechanism having multiple parts, each shaped and together assembled, and geometrically arranged to lock the power plug in the mains power socket when activated, and/or vice versa. In same examples, the method step of operating the safety mechanism is correlated with an activation of a user-operated electromechanical switch assembled, shaped and wired to connect the at least one male-shaped connector of the power plug to the electrical alternating current energy generator when activated, and/or vice versa.

This Summary section is neither intended nor should be construed as being representative of the full extent and scope of the present invention. Additional aspects, advantages, and/or utilities of the presently disclosed technology are set forth in part in the attached figures, the description that follows and as embodied by the claims and, in part, will be apparent from the description, or may be learned by practice of the presently disclosed technology. Furthermore, the disclosure should be understood by those of ordinary skill in the art to encompass obvious improvements and modifications thereto. Accordingly, this Summary does not contain all of the aspects and embodiments of the present inventive concept and is not meant to be limiting or restrictive in any manner.

### BRIEF DESCRIPTION OF THE DRAWINGS

So that the manner in which the features, advantages, and objects of the technology, as well as others which will become apparent, are attained, and can be understood in more detail, more particular description of the technology briefly summarized above may be had by reference to the embodiments thereof which are illustrated in the appended drawings that form a part of this specification. It is to be noted, however, that the drawings illustrate only certain embodiments of the disclosed technology and are therefore not to be considered limiting of its scope as the disclosed technology may admit to other equally effective embodiments.

FIG. 1 shows a block diagram and an energy flow chart of an exemplary embodiment of a system to connect an electrical power source to an mains grid installation in accordance with one or more embodiments of the presently disclosed technology.

FIG. 2 shows perspective view illustrations of exemplary embodiments of a power plug, each including a safety mechanism in accordance with one or more embodiments of the presently disclosed technology.

FIG. 3 shows a perspective view and several functional illustrations of an exemplary embodiment of a safety mechanism in accordance with one or more embodiments of the presently disclosed technology.

FIG. 4 shows a partial cross-sectional view illustration of an exemplary embodiment of a locking mechanism in accordance with one or more embodiments of the presently disclosed technology.

FIG. 5 shows a partial cross-sectional view illustration of an exemplary embodiment of a deploying/retracting mechanism of connectors in accordance with one or more embodiments of the presently disclosed technology.

FIG. 6 shows a partial cross-sectional view illustration of an exemplary embodiment of a pin-based tactile assembly in accordance with one or more embodiments of the presently disclosed technology.

FIG. 7 shows a partial cross-sectional view illustration of an exemplary embodiment of a sheath-based tactile assembly in accordance with one or more embodiments of the presently disclosed technology.

FIG. 8 shows a flow diagram for a plurality of method steps for operating a renewable energy source and connecting the energy source to a mains power grid in accordance with one or more embodiments of the presently disclosed technology.

FIG. 9 shows a flow diagram for a plurality of method steps for operating a renewable energy source and disconnecting the energy source from a mains power grid in accordance with one or more embodiments of the presently disclosed technology.

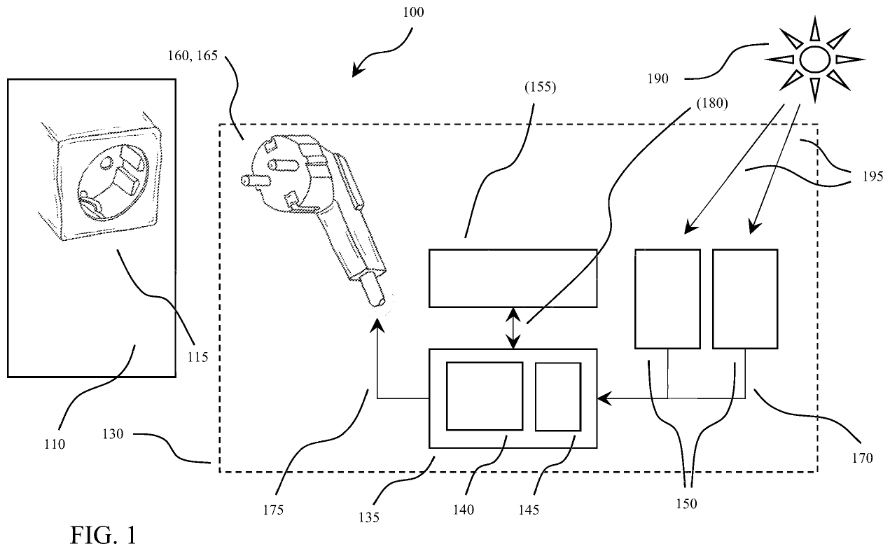

It should be noted that the first digit of a three-number numeral representing an element in the drawings refers to the number of the respective figures FIG. 1 to FIG. 9. In the event, an element is described hereinafter with references including more than one three-number numeral, the word “and” in the enumeration of references shall be deemed in each case to include the combination “and/or”. If an element is described hereinafter with references including one or more three-number numerals, like elements without three-number numerals are deemed to be included in the description, and the reference or the enumeration of references shall be deemed in each case to be followed by the words “unless the context requires otherwise”. In the event, a description is made hereinafter with references to more than one figure, the word “and” or “or” in the enumeration of references shall be deemed in each case to include the combination “and/or”. If a description is made hereinafter with references to one or more figures, the reference or enumeration of references shall be deemed in each case to be followed by the words “unless the context requires otherwise”. An element described herein shall be deemed to include like elements discussed throughout this specification unless the context requires otherwise.

### DETAILED DESCRIPTION

The presently disclosed technology will now be described more fully hereinafter with reference to the accompanying drawings, which illustrate embodiments of the presently disclosed techniques. This technology may, however, be embodied in many different forms and should not be construed as limited to the illustrated embodiments set forth herein. Rather, these embodiments are provided so that this disclosure will be thorough and complete, and will fully convey the scope of the presently disclosed technology to those skilled in the art. Like numbers refer to like elements throughout. The different numbering of identical or similar components and/or prime notation, if used, indicates similar elements in alternative embodiments and/or configurations.

Throughout this specification the term “renewable energy”, and derivative or similar words shall be understood as being generic to all possible meanings supported by the specification and by the words itself; the meaning shall, however, include herein, without limiting the foregoing and unless the context requires otherwise, any energy that is of low-carbon nature, by way of example, not limitation solar power, wind power, and geothermal power.

Throughout this specification the term “live”, and derivative or similar words shall be understood as being generic to all possible meanings supported by the specification and by the words itself; the meaning shall, however, include herein, without limiting the foregoing and unless the context requires otherwise, any conductor or device to which voltage and/or current is applied, or at which voltage and/or current is present or any conductor or device at risk that voltage and/or current becomes applied.

Throughout this specification the term “safety mechanism”, and derivative or similar words shall be understood as being generic to all possible meanings supported by the specification and by the words itself; the meaning shall, however, include herein, without limiting the foregoing and unless the context requires otherwise, any mechanical, electromechanical, and/or electronic part, assembly, wiring and/or function that features a safeguard measure.

Throughout this specification the term “wired”, and derivative or similar words shall be understood as being generic to all possible meanings supported by the specification and by the words itself; the meaning shall, however, include herein, without limiting the foregoing and unless the context requires otherwise, anything that is connected, hard wired, and/or soft wired by electronic logic.

Throughout this specification the term “standard”, and derivative or similar words shall be understood as being generic to all possible meanings supported by the specification and by the words itself; the meaning shall, however, include herein, without limiting the foregoing and unless the context requires otherwise, any national, supra national, or international standard, by way of example, not limitation IECEE, CEE, ANSI, DIN, VDE, EN, or ISO standards.

The system(s) and method(s) provided by the various embodiments of the present technology comprise several independent novel and nonobvious features providing substantial improvements. The greatest benefit can be achieved in the field of connecting decentralized renewable energy sources to an electrical power grid.

One or more of the objects and/or features described in this, the preceding and the following paragraph(s) may be combined in any combination and in no or in any order. One or more of the method, process and/or function steps described in this, the preceding and the following paragraph(s) may be combined in any combination and in no or in any order. One or more of the objects described in this, the preceding and the following paragraph(s) may be configured to carry out one or more of the method, process and/or function steps disclosed in this, the preceding and the following paragraph(s) in any combination and in no or in any order.

Embodiments of the subject matter may be described herein in terms of functional and/or logical block components, and with reference to symbolic representations of operations, processing tasks, and functions that may be performed by various electric and/or electronic components or devices.

Some objectives of the disclosed technology include enabling an end-user to generate locally renewable energy and connect, for example, a solar energy generator to a mains power installation of a residence, or a business connected to the electrical grid without the need of an electrician or engineer, so that systems disclosed herein can be efficiently used in the context of low-carbon strategies of modern societies.

FIG. 1 shows a block diagram and an energy flow chart of an exemplary embodiment of a system to connect an electrical power source to an mains grid installation in accordance with one or more embodiments of the presently disclosed technology.

The block diagram 100 of FIG. 1 depicts in one or more exemplary embodiments of the present technology a system 130 to generate and distribute renewable energy to a mains power installation of a residence, or a business connected to an electrical grid 110, supplying, for example, an alternating current (AC) electrical power having a voltage of 230 V, and a frequency of 50 Hz, or having a voltage of 120 V, and a frequency of 60 Hz. An electrical mains power socket 115 is wired to the mains power installation 110 is, for example, a so called SCHUKO (abbreviation of Schutzkontakt, German for “protective contact”) wall socket conforming to IECEE 7/3 (IECEE is the International Electrotechnical Commission System of Conformity Assessment Schemes for Electrotechnical Equipment and Components) that features, for example, a socket 17.5 mm deep, having two symmetrical round apertures that center 19 mm apart, with female-shaped connectors behind to receive two round pin connectors of 4.8 mm diameter, 19 mm long for the electrical line and neutral contacts and two earthing clips on the sides of the socket positioned to ensure that the protective earth (ground) contact is always engaged before a live pin contact is made. The system 130 to generate and distribute renewable energy is, for example a solar power generator 130 that includes, for example one or more solar panels 150 comprising photovoltaic cells converting sunlight 195 radiated by the sun 190 into an electric current using a photovoltaic effect, for example into direct current (DC) electrical power having a nominal voltage of 18.15 V. Each solar panel 150 may consist of 99 photovoltaic cells assembled and arranged in a sheet-type housing having main dimensions of 900 mm×540 mm×2 mm being waterproof and conforming to the protective code (Ingress Protection Code as defined in IEC 60529) IP67. Each solar panel 150 may provide a nominal electrical power of up to 80 W, at a nominal current of 4.4 A. Each solar panel 150 is, for example, connected and wired to a power inverter 135 that includes an electronic power inverter unit 140 and a control unit 145. The electronic power inverter unit 140 may convert the electrical energy from low voltage direct current (DC) (e.g., 20 V to 60 V) 170 to mains level voltage alternating current (AC) (e.g., 184 V to 265 V, 45 Hz to 55 Hz) 175, having an electrical power of 600 W, and a degree of efficiency of 99%. The control unit 145 may include one or more microcontroller or processors, operationally connected to a non-transitory processor-readable medium, e.g., a solid state erasable programmable read-only memory (EPROM) and a static random-access memory (SRAM), comprising the program code and data to control the power conversion or inversion. The control unit 145 is, for example, wired and programed to control the generation of alternating current (AC) electrical energy 175 by the electronic power inverter unit 140 to drive the alternating current energy 175 into the electrical grid 110, synchronizing the electronic power inverter unit 140 that functions as a generator or energy source with the grid 110 to have the same or similar frequency, phase, phase sequence, and voltage. Further, the power inverter 135 may be wired and thereby connected to a mains power plug 160. The power plug 160 may be shaped to conform to and to be inserted into the mains power socket 115. The power plug 160 is, for example, a SCHUKO mains power plug, conforming to IECEE 7/4, having a housing and a base, two male-shaped connectors conforming to corresponding female-shaped connectors of the mains power socket 115, e.g., symmetrical connector pins that center 19 mm apart of 4.8 mm diameter, 19 mm long for the line and neutral contacts, and two flat contact areas on each side of the plug for protective earth (ground). The power plug 160 may have two internal contacts to connect and wire the power plug 160 to the power inverter 135. A system comprising the power socket 160, a power inverter 135, and one or more solar panels 150 might be configured to be used by an end-user of a mains electrical installation, for example on the roof or on a balcony in a residency, office or shop without the need of an electrician to perform the installation. In another exemplary embodiment of the present technology, the power inverter 135 is connected with a battery unit 155 to store electrical energy 180 when sunlight 195 shines on the solar panels, and to provide electrical energy 180 when the solar panels 150 are not producing energy 170. In yet another exemplary embodiment of the present technology, the mains power socket 115 and the power plug 160 conform to one or more national, supranational, or international standards.

In one or more exemplary embodiments of the present technology, as the power plug 160 is wired and connected to an energy source, e.g., the power inverter 135 that may be live and under voltage, the power plug 160 may comprise an integrated safety mechanism 165 assembled, shaped and/or wired to protect a user or a bystander from a hazardous live contact with a male-shaped connector erecting from the base of the power plug 160 when the system 130 is in operation and the power plug 160 is unplugged. For example, the safety mechanism 165 of the power plug 160 includes a user-operated locking mechanism having multiple parts, each shaped and together assembled and geometrically arranged to lock the power plug 160 in the mains power socket 115. The safety mechanism 165 may be user-operated requiring a key. The safety mechanism 165 may include an electromechanical switch assembled, shaped and wired to disconnect one or more male-shaped connector(s) from a corresponding internal contact(s) connected and wired or connectable to be wired to the renewable energy source, e.g., a solar energy generator 135/150 when the power plug 160 is unplugged. In one or more exemplary embodiments of the present technology, the safety mechanism 165 may detect if the power plug 160 is operationally inserted in the mains power socket 115, for example, by a tactile assembly and/or by an optoelectronic, Hall effect or other electronic or electromechanical sensor or sensor system. In an exemplary embodiment of the present technology, a magnet is placed in a safety pad to be inserted and adhesively affixed in the bottom of a mains power socket 115, and a Hall effect sensor integrated in the power plug 160 detects the magnet, and thereby that the power plug 160 is operationally inserted in the mains power socket 115. In the event that mains power socket 115 and the power plug 160 conform to IECEE 7, the safety pad may have a main diameter of 38 mm with cutouts for the earthing clips and the intertwined side parts and a pad thickness of 2 mm, and two symmetrical apertures, or bore holes that center 19 mm apart, each having a diameter of 6 mm to accommodate the male-shaped connectors of the power plug 160 extending from its base. The tactile assembly or the other sensors, e.g., the Hall effect sensor, may operate an electronic or electromechanical switch, disconnecting the male-shaped connectors of the power plug 160 from the connectors wiring and connecting the power plug 160 with the power inverter 135 when the power plug 160 is unplugged, and, vice versa, connecting the male-shaped connectors of the power plug 160 with the connectors wiring and connecting the power plug 160 with the power inverter 135 when the power plug 160 is operationally inserted and placed in the mains power socket 115. Further, the safety mechanism 165, may include a manually operated switch, released by a tactile assembly when the power plug 160 is operationally inserted and placed in the mains power socket 115, the manually operated switch to be operated by a user, connecting or disconnecting the male-shaped connectors of the power plug 160 from the internal connectors wiring and connecting the power plug 160 with the power inverter 135. The manually operated switch may include and drive a locking mechanism, that prevents the power plug 160 to be removed from the mains power socket 115 when the switch is operated to connect the male-shaped connectors of the power plug 160 with the internal connectors wiring and connecting the power plug 160 with the power inverter 135. In yet another exemplary embodiment of the present technology, the manually operated switch may include a deploying/retracting mechanism causing the male-shaped connectors of the power plug 160 to be forwarded and thereby deployed when the power plug 160 is operationally inserted and placed in the mains power socket 115, and, vice versa, retracted inside the housing and thereby electrically covered and isolated when the power plug 160 is unplugged. Further, in yet another exemplary embodiment of the present technology, the safety mechanism 165 may include at least one isolation sheath covering and isolating the at least one male-shaped connector of the power plug 160 from a hazardous contact with a user or bystander that are deployable and retractable. The at least one isolation sheath may be pushed forward outside the housing by a spring mechanism, and, in reverse, may be pushed into the housing by pressing against the base of housing of the mains power socket 115 and thereby operationally deploying the at least one male-shaped connector of the power plug 160 when the power plug 160 is inserted into the mains power socket.

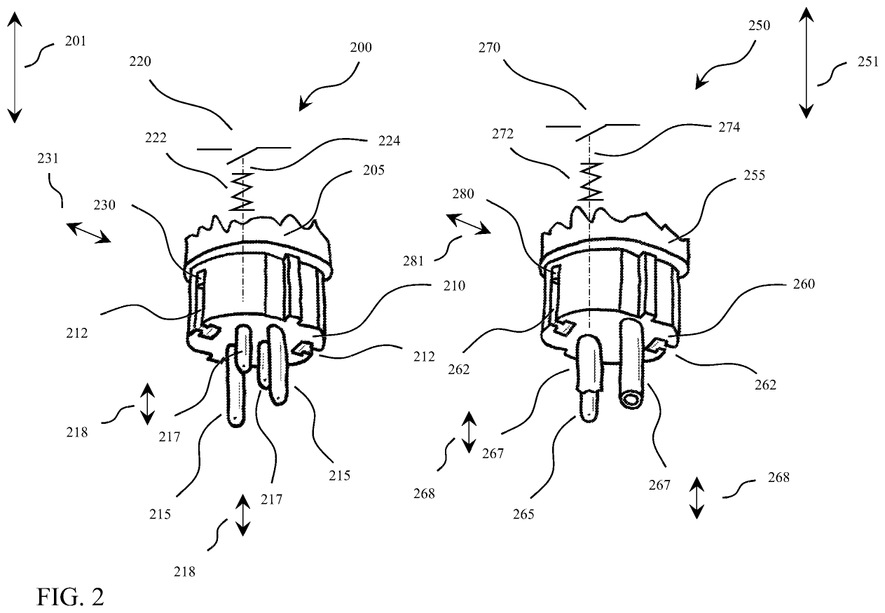

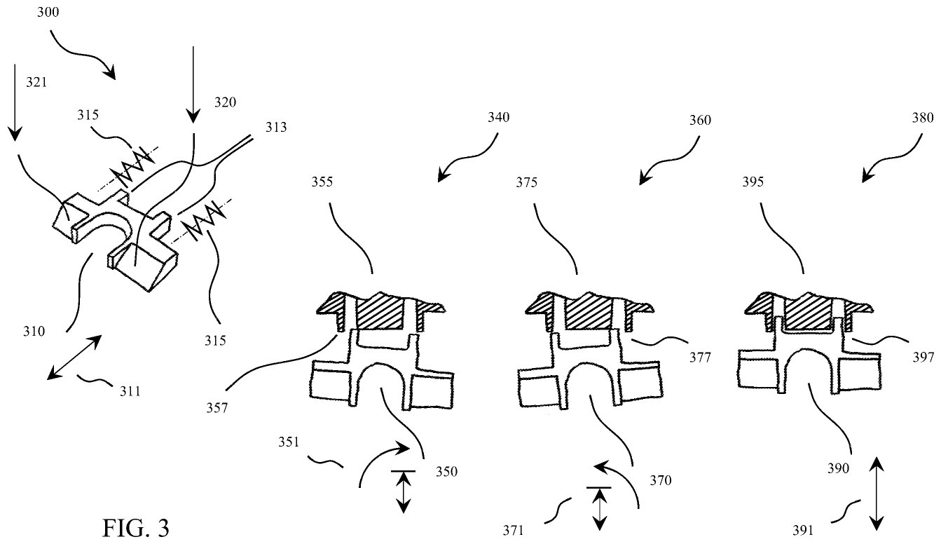

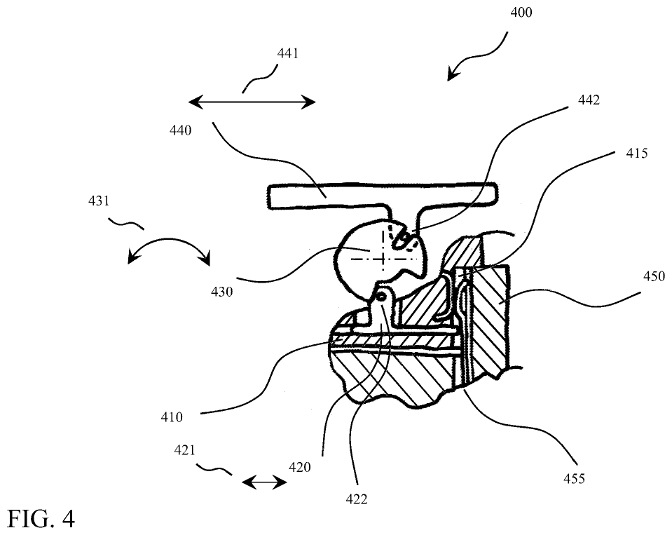

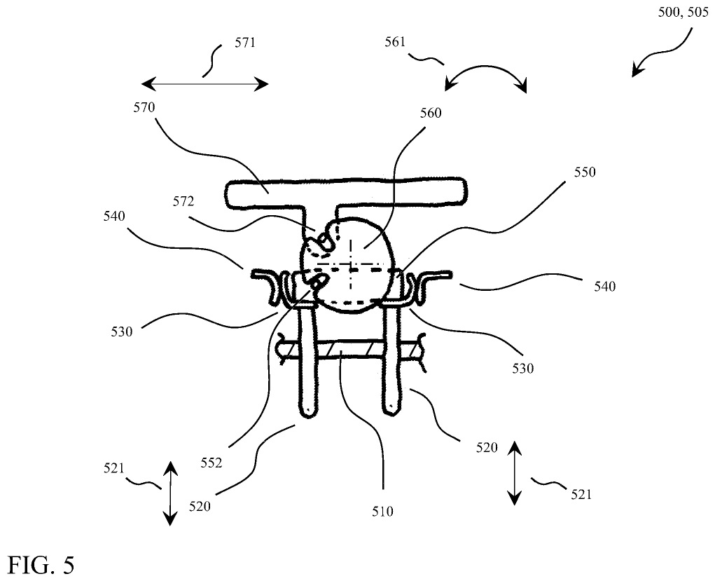

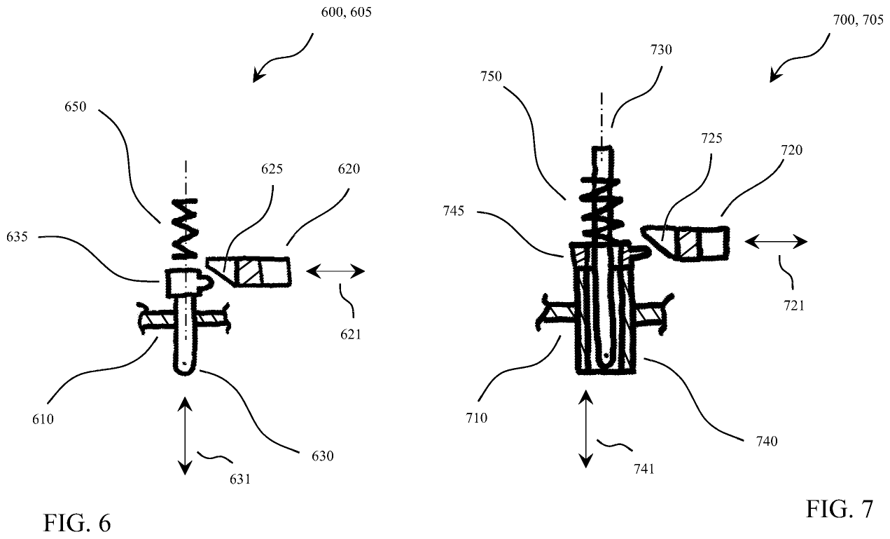

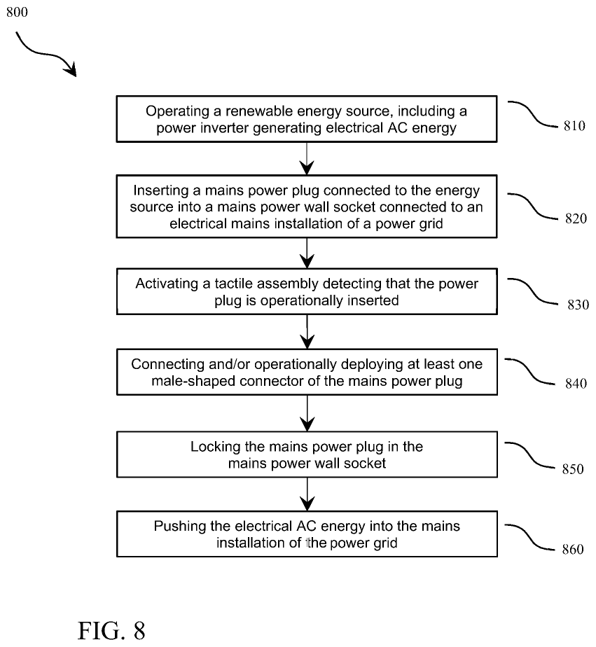

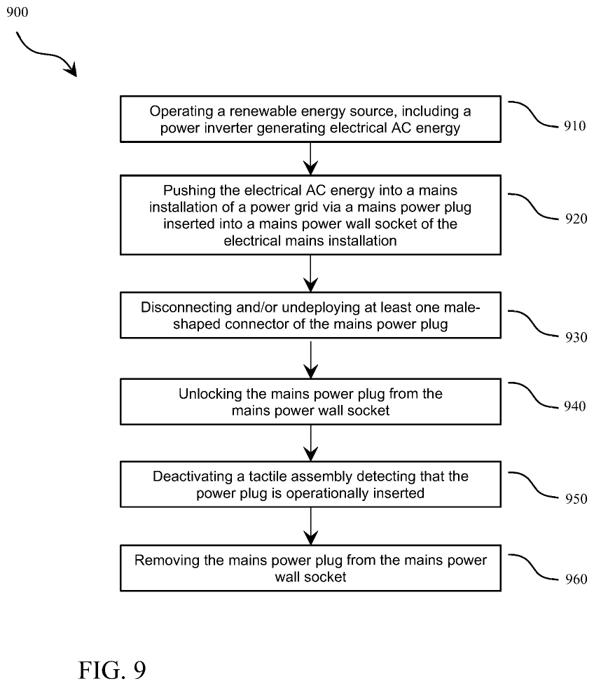

Some examples of details of the power plug 160 and of the safety mechanism 165 shown and described in reference to FIG. 1 are further shown in, discussed in reference to, and/or further detailed in reference to FIG. 2, FIG. 3, FIG. 4, FIG. 5, FIG. 6, and FIG. 7, or any of the FIGS. discussed herein, and vice versa. Some method and/or operational steps described in reference to FIG. 1 are discussed, shown, and/or further detailed in FIG. 2, FIG. 3, FIG. 4, FIG. 5, FIG. 6, FIG. 7, FIG. 8, and FIG. 9, or any of the FIGS. discussed herein. The power inverter 135, the renewable energy source 135/150/195, the power plug 160, the housing, the base, the mains power socket 115, the safety mechanism 165, the male-shaped connector(s), the contact(s) of the power plug 160 to connect the power plug 160 to the power inverter 135, the earth contact area(s), the earthing clip(s), the tactile assembly and/or optoelectronic, Hall effect or other electronic or electromechanical sensors, the electronic or electromechanical switch, the manually operated switch, the locking mechanism, the spring(s), the deploying/retracting mechanism of the male-shaped connector(s), the deployable/retractable isolation sheath(s), and each's details, each as shown in and/or described with respect to FIG. 1 may represent the same or similar power inverter, renewable energy source, power plug 200, 250, and 410, housing 205, and 255, base 210, 260, 410, 510, 610, and 710, mains power socket 450, safety mechanism 300, connector(s) 215, 265, 520, and 730, contact(s) 540, earth contact area(s) 212, 262, and 415, earthing clip(s) 455, tactile assembly, electronic or electromechanical sensors or sensor systems, electronic or electromechanical switch 220, 270, and 530/540, manually operated switch 440, and 570, spring(s) 222, 272, 315, 650, and 750, locking mechanism 400, deploying/retracting mechanism of the male-shaped connector(s) 500, deployable/retractable isolation sheath(s) 267, and 740, or each's details, respectively, as shown in and/or described with respect to FIG. 2, FIG. 3, FIG. 4, FIG. 5, FIG. 6, FIG. 7, FIG. 8, and FIG. 9, or any of the FIGS. discussed herein, and vice versa.

FIG. 2 shows perspective view illustrations of exemplary embodiments of a power plug, each including a safety mechanism in accordance with one or more embodiments of the presently disclosed technology.

The two illustrations depicted in FIG. 2, are perspective views of the same or similar power plug 200, and 250 that show in one or more exemplary embodiments of the present technology the same or similar housing 205, and 255, base 210, and 260, male-shaped connectors 215, and 265, earth contact areas 212, and 262, tactile assembly 222/217/218, and 267/268/272, electronic or electromechanical switch 224/220, 274/270, and 530/540, spring 222, and 272, and movable locking pin 230, and 280. For example, the power plug 200, and 250 is a SCHUKO mains power plug, conforming to IECEE 7/4, connected to a power inverter of a renewable energy source. Various exemplary embodiments of safety mechanisms are integrated in the power plug 200, and 250, each assembled, shaped and/or wired to protect a user or a bystander from a hazardous live contact with one or more male-shaped connectors 215, and 265, erecting from the base 210, and 260, of the power plug 200, and 250, when the energy source is in operation and the power plug 200, and 250 is unplugged. These various exemplary embodiments of safety mechanisms can be combined and/or inter-operationally connected and may be further combined and/or inter-operationally connected with various exemplary embodiments shown and or described FIG. 1, FIG. 3, FIG. 4, FIG. 5, FIG. 6, and FIG. 7, and operated as shown and/or described in FIG. 8, and FIG. 9, or any of the FIGS. discussed herein. The direction of the movement 201, and 251 as depicted in FIG. 2 indicates the direction of an insertion path to insert the power plug 200, and 250 into a corresponding mains power socket, which might be a wall mounted socket. The movable locking pin 230, and 280 may be shaped, assembled, and positioned to be either retracted within the hosing 205, and 255, so that the insertion of the power plug 200, and 250 into or the removal from the correlating mains power socket is not obstructed, or pushed outwards to hook underneath a cutout in a housing of a mains power socket accommodating an earthing clips on either side of the mains power socket correlating to earth contact areas 212, and 262 so that the power plug 200, and 250 is locked within the mains power socket. The direction of the movement 231, and 281 of the movable locking pin 230, and 280 is depicted in FIG. 2. As the mains power socket might be symmetrical in respect to the configuration of the earthing clips and the correlating cutouts of the housing of the mains power socket, the movable locking pin 230, and 280 may be present and arranged symmetrically on either side of power plug 200, and 250. Alternatively, the movable locking pin 230, and 280 may be shaped, assembled, and positioned closer to the base 210, and 260 to hook underneath the earthing clips itself to serve the same or similar function, as, for example, shown and described in FIG. 4, or any of the FIGS. discussed herein. In another exemplary embodiments of the present technology a user-operated locking mechanism may by assembled, shaped and positioned to drive an eccentric or spreading portion of at least one male-shaped connector 215, and 265 of the power plug 205, and 255 to dimensionally exceed the cylindrical portion of the male-shaped connector 215, and 265 and thereby hooking underneath one correlating round aperture of a housing of a correlating mains power socket that accommodates the male-shaped connector 215, and 265, when the power plug 200, and 250 is inserted in the mains power socket to thereby block a removal path of the power plug 200, and 250 from the mains power socket. In another exemplary embodiment of the present technology, the safety mechanism of power plug 200, and 250 includes an integrated tactile assembly, having multiple parts, each shaped and together assembled and geometrically arranged to detect if the power plug is unplugged. Each tactile assembly may include one or more tactile parts 217, and 267, each tactile part 217, and 267 of the one or more tactile parts 217, and 267 having a longitudinal extension and a longitudinal axis, each tactile part is pushed outwards of the housing mainly in the direction of its longitudinal axis in the corresponding moving direction 218, and 268, for example, by a correlating spring 222, and 272. Each such longitudinal axis may be geometrically positioned in relation to the base 210, and 260 of the housing 205, and 255 of the power plug 200, and 250 mainly in line with the direction of the insertion path 201, and 251 of the power plug 200, and 250 into a corresponding mains power socket so that the at least one tactile part 217, and 267 are pushed into the housing 205, and 255 by a base portion of the housing of the corresponding mains power socket when the power plug 200, and 250 is operationally positioned in the mains power socket. An actuator mechanism 224, and 274 may direct the movement(s) of the one or more tactile parts 217, and 267 to thereby operating an electromechanical switch 220, and 270 to close an electrical connection between one or more male-shaped connectors 215, and 265 with one or more corresponding internal contacts within the housing 205, and 255 that are, for example, connected and wired or connectable to one or more wires of a mains cable of the power plug 200, and 250. For example, the one or more tactile parts 217 of the power plug 200, are pins 217, each of, for example, 3.2 mm in diameter, 12 mm long in its dimension extending from the base 210, that are forced to its end position by the spring 222, having at this enclosing assembly configuration at that position a force of, for example, 2 N. In yet another exemplary embodiment of the present technology, the one or more tactile parts 267 are isolation sheaths 267, each covering and electrically isolating a corresponding male-shaped connector 265. Of the power plug 250. Each isolation sheath 267 is made, for example of polyamide, PA6 and shaped, for example, cylindrically, having an inner diameter of 5.0 mm, and outer diameter of 6.0 mm, and a length extending from the base 260 of 23 mm, to accommodate and electrically shielding a corresponding male-shaped connector 265, which is, for example, cylindrically pin-shaped, having a diameter of 4.8 mm, and a length extending from the base of 19 mm. Each isolation sheath 267 may be forced to its end position by a spring 272, having at this enclosing assembly configuration at that position a force of, for example, 2 N. The tactile parts 217, and 267 of the tactile assembly may in one or more exemplary embodiments of the present technology interact with a movable locking element assembled, shaped and geometrically arranged to prevent that only one tactile part 217, and 267 of for example at least one tactile part 217, and 267 can be pushed into the housing 205, and 255 of the power plug 200, and 250. The movable locking element may be the same or similar movable locking element 310, 350, 370, 390, 620, and 720 as shown and described in FIG. 3, FIG. 6, and FIG. 7, or any of the FIGS. discussed herein.

In one or more exemplary embodiments of the present technology, the safety mechanism of power plug 250 may include an integrated tactile assembly, having multiple parts, each shaped and together assembled and geometrically arranged to detect if the power plug is unplugged, wherein, for example, the tactile assembly includes one or more tactile isolation sheaths 267, each tactile isolation sheath may have a longitudinal extension and a first longitudinal axis, each tactile isolation sheath 267 may be pushed outwards of the housing 255 mainly in the direction 268 of its first longitudinal axis by a spring 272, the first longitudinal axis may be geometrically positioned mainly in line to a second longitudinal axis of a corresponding male-shaped connector 265 so that the one or more tactile isolation sheaths 267 may be pushed into the housing 255 of the power plug 250 when the power plug 250 is operationally positioned in a correlating mains power socket to thereby uncovering and operationally expose corresponding male-shaped connector 265. Moreover, in another exemplary embodiment of the present technology, the safety mechanism integrated in the power plug 200, and 259, includes an electromechanical switch 220, and 270 assembled, shaped and wired to disconnect each one of the one or more male-shaped connectors 215, and 265 from a corresponding contact within the housing 205, and 255 when the power plug is unplugged, wherein each such contact is, for example, connected and wired or connectable to be wired to a renewable energy source.

Some examples of details of the power plug 200 and of the safety mechanism shown and described in reference to FIG. 2 are further shown in, discussed in reference to, and/or further detailed in reference to FIG. 1, FIG. 3, FIG. 4, FIG. 5, FIG. 6, and FIG. 7, or any of the FIGS. discussed herein, and vice versa. Some method and/or operational steps described in reference to FIG. 2 are discussed, shown, and/or further detailed in FIG. 1, FIG. 3, FIG. 4, FIG. 5, FIG. 6, FIG. 7, FIG. 8, and FIG. 9, or any of the FIGS. discussed herein. The power inverter, the renewable energy source, the power plug 200, and 250, the housing 200, and 250, the base 210, and 260, the mains power socket, the safety mechanism, the male-shaped connector(s) 215, and 265, the contact(s) of the power plug 200, and 250 to connect the power plug 200, and 250, the earth contact area(s) 212, and 262, the earthing clip(s), the tactile assembly and/or optoelectronic, Hall effect or other electronic or electromechanical sensor or sensor systems, the electronic or electromechanical switch 220, and 270, the manually operated switch, the locking mechanism, the spring(s) 222, and 272, the deploying/retracting mechanism of the male-shaped connector(s), the deployable/retractable isolation sheath(s) 267, and each's details, each as shown in and/or described with respect to FIG. 2 may represent the same or similar power inverter 135, renewable energy source 135/150/195, power plug 160, and 410, housing, base 410, 510, 610, and 710, mains power socket 115, and 450, safety mechanism 165, and 300, connector(s) 520, and 730, contact(s) 540, earth contact area(s) 415, earthing clip(s) 455, tactile assembly, electronic or electromechanical sensor or sensor systems, electronic or electromechanical switch 530/540, manually operated switch 440, and 570, spring(s) 315, 650, and 750, locking mechanism 400, deploying/retracting mechanism of the male-shaped connector(s) 500, deployable/retractable isolation sheath(s) 740, or each's details, respectively, as shown in and/or described with respect to FIG. 1, FIG. 3, FIG. 4, FIG. 5, FIG. 6, FIG. 7, FIG. 8, and FIG. 9, or any of the FIGS. discussed herein, and vice versa.

FIG. 3 shows a perspective view and several functional illustrations of an exemplary embodiment of a safety mechanism in accordance with one or more embodiments of the presently disclosed technology.

The four illustrations depicted in FIG. 3, include a perspective view 300 and three operational illustrations 340, 360, and 380 that show in one or more exemplary embodiments of the present technology the same or similar movable locking element 310, 350, 370, and 390, gate 355, 375, and 395, gating surface 357, 377, and 397, and locking surface 313. The movable locking element 310, 350, 370, and 390, and the gate 355, 375, and 395 may be part of a safety mechanism or tactile assembly to distinguish and block a first operation where only one moving tactile element is pushed onto a correlating angled surface of the movable locking element 310, 350, 370, and 390 either in direction 321 or in direction 320 from a second operation, where at least one moving tactile element (not shown in this FIGURE) are pushed onto a correlating angled surface of the movable locking element 310, 350, 370, and 390 in direction 321 and in direction 320 simultaneously and allowed to move by the movable locking element 310, 350, 370, and 390. The springs 315, for example, push the movable locking element 310, 350, 370, and 390 forward in direction 311, and 391 against potential forces caused by one or two movable tactile elements (not shown in this FIGURE) pushing on the correlating angled surface(s) of the movable locking element 310, 350, 370, and 390. An encasement may be shaped to hold the movable locking element 310, 350, 370, and 390 in a geometrical position and orientation in spatial relation to the at least two movable tactile elements (not shown in this FIGURE), assembled, shaped, and positioned to move in the direction 320 and/or 321. The movable locking element 310, 350, 370, and 390 may have main dimensions of mm×15 mm×3.5 mm. The springs 315 may be preloaded so that the forces required to move the movable locking element 310, 350, 370, and 390 in directions 311, 351, 371, and 391 against the springs 315 require a force of, for example, 0.5 N to 1.0 N. The encasement may provide the play to allow the movable locking element 310, 350, 370, and 390 to move in the directions 311, 351, 371, and 391, for example a linear movement of 5 mm as depicted in illustration 380, and, for example, a linear movement of 0.5 mm in combination with a rotational movement of plus or minus as depicted in illustrations 340, and 360, where, for example, the linear movement is blocked by the interaction between the locking surface 313 of movable locking element 310, 350, 370, and 390 with the gating surface 357, 377, and 397 of the gate 355, 375, and 395, which may be part of the encasement.

The aforementioned movable tactile elements (not shown in this FIGURE) may be the tactile parts or pins 217, and 630 moving in direction 218, and 631 as described and/or shown in FIG. 2, and FIG. 6, or any of the FIGS. discussed herein, so that a safety mechanism may be assembled, shaped and geometrically arranged to prevent that only one tactile part or pin of at least two tactile parts or pins can be pushed into the housing of the power plug so that the electromechanical switch is only operated to close when the at least two tactile parts or pins are simultaneously pushed into the housing of the power plug. The aforementioned movable tactile elements (not shown in this FIGURE) may be the tactile parts or pins 217, and 630 moving in direction 218, and 631 as described and shown in FIG. 2, and FIG. 6, or any of the FIGS. discussed herein, so that a entire safety mechanism may be assembled, shaped and geometrically arranged to prevent that only one tactile part or pin of the at least two tactile parts or pins can be pushed into the housing of the power plug so that a locking mechanism, a manually operated switch and/or a key can only be operated when the at least two tactile parts or pins are simultaneously pushed into the housing of the power plug. The aforementioned movable tactile elements (not shown in this FIGURE) may be the tactile parts or isolation sheaths 267, and 740 moving in direction 268, and 741 as described and/or shown in FIG. 2, FIG. 7, or any of the FIGS. discussed herein, so that a safety mechanism may be assembled, shaped and geometrically arranged to prevent that only one tactile isolation sheath of the at least two tactile isolation sheaths can be pushed into the housing of the power plug so that the at least two male-shaped connectors are only uncovered and operationally exposed when the at least two tactile isolation sheaths are simultaneously pushed into the housing of the power plug.

Some examples of details of the power plug, the safety mechanism, the tactile assembly, and the movable locking element 310, 350, 370, and 390 shown and described in reference to FIG. 3 are further shown in, discussed in reference to, and/or further detailed in reference to FIG. 1, FIG. 2, FIG. 4, FIG. 5, FIG. 6, and FIG. 7, or any of the FIGS. discussed herein, and vice versa. Some method and/or operational steps described in reference to FIG. 3 are discussed, shown, and/or further detailed in FIG. 1, FIG. 2, FIG. 4, FIG. 5, FIG. 6, FIG. 7, FIG. 8, and FIG. 9, or any of the FIGS. discussed herein. The power plug, the housing, the mains power socket, the safety mechanism, the male-shaped connector(s), the tactile assembly, the electronic or electromechanical switch, the manually operated switch, the locking mechanism, the deploying/retracting mechanism of the male-shaped connector(s), the deployable/retractable isolation sheath(s), and each's details, each as shown in and/or described with respect to FIG. 3 may represent the same or similar power plug 160, 200, and 250, housing 200, and 250, mains power socket 115, and 450, safety mechanism 165, and 300, connector(s) 215, 265, 520, and 730, tactile assembly, electronic or electromechanical switch 220, 270, and 530/540, manually operated switch 440, and 570, locking mechanism 400, deploying/retracting mechanism of the male-shaped connector(s) 500, deployable/retractable isolation sheath(s) 267, and 740, or each's details, respectively, as shown in and/or described with respect to FIG. 1, FIG. 2, FIG. 4, FIG. 5, FIG. 6, FIG. 7, FIG. 8, and FIG. 9, or any of the FIGS. discussed herein, and vice versa.

FIG. 4 shows a partial cross-sectional view illustration of an exemplary embodiment of a locking mechanism in accordance with one or more embodiments of the presently disclosed technology.

The locking mechanism 400 as depicted in FIG. 4 shows in one or more exemplary embodiments of the present technology a mains power socket 450 including a earthing clip 455, a power plug 410, an earthing area 415, and a locking gear comprising a user-operated switch 440, to be manually moved in the direction 441 to be activated, e.g., locked, or, in reverse, deactivated, e.g., unlocked, a locking bolt 420 moved by the locking gear back and forth in the direction 421 to hook underneath the earthing clip 455 of the mains power socket 450 when the user-operated switch 440 is activated, a gear element 430 that can be rotated around an axis in the direction 431 interacting with a driving pin 442 affixed to the user-operated switch 440, and further interacting with a driven pin 422 affixed to the locking bolt 420 translating a locking/unlocking movement of the user-operated switch 440 in the direction 441 to a locking/unlocking movement of the locking bolt 420 in the direction 421. The locking bolt 420 may be made of polyamide, PA6 and shaped, for example, having rectangular cross-section of 4.0 mm×2.0 mm extending next to the base from the housing of the power plug 410 in the direction 421 towards the earthing clip 455 so that the 4.0 mm dimension extends parallel to the main extension of the base of the power plug 410, perpendicular to the insertion path of the power plug 410 into the mains power socket 450, and so that the 2.0 mm dimension extends in the direction of the insertion path of the power plug 410 into the mains power socket 450. When locked, a removal path of the power plug 410 from the mains power socket 450 may be blocked. The user-operated switch 440 may be blocked to be operated, when the power plug 410 is not operationally inserted into the mains power socket 450. Such blockage could be caused by an extension to the movable locking element 310, 350, 370, and 390 as depicted in and/or described in reference to FIG. 3, or any of the FIGS. discussed herein operated by tactile parts 217, 267, 630, and 740 as depicted in and/or described in reference to FIG. 2, FIG. 3 and FIG. 4, or any of the FIGS. discussed herein. The user-operated switch 440 may further operate an electromechanical switch 220, and 270 as depicted in and/or described in reference to FIG. 2, or any of the FIGS. discussed herein, assembled, shaped and wired to disconnect one or more male-shaped connectors from a corresponding internal contact within the housing of the power plug 410 when the power plug 410 is unplugged, wherein each such contact is, for example, connected and wired or connectable to be wired to a renewable energy source. The user-operated switch 440 may further operate an retraction/deployment mechanism 500, or a portion thereof as shown and/or described with respect to FIG. 5, or any of the FIGS. discussed herein. In another exemplary embodiment of the present technology, the safety mechanism includes a user-operated locking mechanism 400 having multiple parts, each shaped and together assembled and geometrically arranged to lock the power plug 410 in the mains power socket 450 when inserted. In yet another exemplary embodiment of the present technology, the safety mechanism may further include a tactile assembly having multiple parts, each shaped and together assembled and geometrically arranged to detect if the power plug is unplugged, the tactile assembly being further shaped and arranged to block the user-operated locking mechanism 400 when the power plug 410 is unplugged.

Some examples of details of the power plug 410, the housing, the base, the mains power socket 450, the safety mechanism, the tactile assembly, and the locking mechanism 400 shown and described in reference to FIG. 4 are further shown in, discussed in reference to, and/or further detailed in reference to FIG. 1, FIG. 2, FIG. 3, FIG. 5, FIG. 6, and FIG. 7, or any of the FIGS. discussed herein, and vice versa. Some method and/or operational steps described in reference to FIG. 4 are discussed, shown, and/or further detailed in FIG. 1, FIG. 2, FIG. 3, FIG. 5, FIG. 6, FIG. 7, FIG. 8, and FIG. 9, or any of the FIGS. discussed herein. The power plug 410, the mains power socket 450, the housing, the safety mechanism, the male-shaped connector(s), the tactile assembly, the electronic or electromechanical switch, the manually operated switch 440, the locking mechanism 400, the deploying/retracting mechanism of the male-shaped connector(s), the deployable/retractable isolation sheath(s), and each's details, each as shown in and/or described with respect to FIG. 4 may represent the same or similar power plug 160, 200, and 250, housing 200, and 250, mains power socket 115, safety mechanism 165, and 300, connector(s) 215, 265, 520, and 730, tactile assembly, electronic or electromechanical switch 220, 270, and 530/540, manually operated switch 570, locking mechanism, deploying/retracting mechanism of the male-shaped connector(s) 500, deployable/retractable isolation sheath(s) 267, and 740, or each's details, respectively, as shown in and/or described with respect to FIG. 1, FIG. 2, FIG. 3, FIG. 5, FIG. 6, FIG. 7, FIG. 8, and FIG. 9, or any of the FIGS. discussed herein, and vice versa.

FIG. 5 shows a partial cross-sectional view illustration of an exemplary embodiment of a deploying/retracting mechanism of connectors in accordance with one or more embodiments of the presently disclosed technology.

The deploying/retracting mechanism 500 as depicted in FIG. 5 shows in one or more exemplary embodiments of the present technology a power plug 505 having a base 510, at least one male-shaped connector 520 affixed to an isolating bar 550, the at least one male-shaped connector 520 and the isolating bar 550 being movable together in a direction 521 guided by the base 510, a deployment gear comprising a user-operated switch 570, to be manually moved in the direction 571 to be activated, e.g., the at least one male-shaped connector 520 being in a deployed position, or, in reverse, deactivated, e.g., the at least one male-shaped connector 520 being in a retracted position, a gear element 560 that can be rotated in the direction 561 around an axis interacting with a driving pin 572 affixed to the user-operated switch 570, and further interacting with driven pin 530 affixed to the isolating bar 550 translating a deploying/retracting movement of the user-operated switch 570 in the direction 571 to a deploying/retracting movement of the at least one male-shaped connector 520 and the isolating bar 550 in the direction 521. When deployed, the male-shaped connectors 520 may be operationally positioned with respect to the housing of the power plug 505 so that contact is made between the male-shaped connectors 520 and corresponding female-shaped connectors of a mains power socket when the power plug 505 is operationally inserted into the mains power socket. When retracted, for example, the male-shaped connectors 520 are retracted within the housing of the power plug 505 and operationally concealed, e.g., isolated to protect a user or a bystander from a hazardous live contact with a male-shaped connector 520 when the power plug 505 is connected to a renewable energy source and the renewable energy source is in operation and the power plug is unplugged. Each male-shaped connector may be assembled to be in electrical contact with a corresponding part 530 of an electromechanical switch 530/540 so that the electromechanical switch 530/540 connects each one of the at least one male-shaped connector 520 with a corresponding contact 540 when the male-shaped connectors 520 are deployed, and vice versa, wherein each such contact 540 is, for example, connected and wired or connectable to be wired to a renewable energy source. The user-operated switch 570 may be blocked to be operated, when the power plug 505 is not operationally inserted into a corresponding mains power socket. Such blockage could be caused by an extension to the movable locking element 310, 350, 370, and 390 as depicted in and/or described in reference to FIG. 3, or any of the FIGS. discussed herein operated by tactile parts 217, 267, 630, and 740 as depicted in and/or described in reference to FIG. 2, FIG. 3 and FIG. 4, or any of the FIGS. discussed herein. In one or more exemplary embodiments of the present technology, a safety mechanism of the power plug 505 includes a deploying/retracting mechanism 500. The deploying/retracting mechanism 500 may include a user-operated forwarding mechanism assembled, shaped and geometrically arranged to deploy or to retract one or more male-shaped connectors 520 to thereby activate or deactivate the power plug. The male-shaped connector(s) 520 may be retraced and at least partially concealed inside the housing when the power plug 505 is deactivated. The male-shaped connector(s) 520 may be forwarded and thereby operationally deployed when the power plug 505 is activated. In yet another exemplary embodiment of the present technology, the safety mechanism further includes an electromechanical switch assembled, shaped and wired to disconnect or connect at least one male-shaped connector 520 from or with a corresponding contact 540, wherein the user-operated switch 570 is further shaped and arranged to operate the electromechanical switch 530/540 so that an electrical connection between at least one male-shaped connector 520 with a corresponding contact 540 is closed when the deploying/retracting mechanism is activated by a user.

Some examples of details of the power plug 505, the base 510, the mains power socket, the safety mechanism, and the deploying/retracting mechanism 500 shown and described in reference to FIG. 5 are further shown in, discussed in reference to, and/or further detailed in reference to FIG. 1, FIG. 2, FIG. 3, FIG. 4, FIG. 6, and FIG. 7, or any of the FIGS. discussed herein, and vice versa. Some method and/or operational steps described in reference to FIG. 5 are discussed, shown, and/or further detailed in FIG. 1, FIG. 2, FIG. 3, FIG. 4, FIG. 6, FIG. 7, FIG. 8, and FIG. 9, or any of the FIGS. discussed herein. The power plug 505, the mains power socket, the base, the safety mechanism, the male-shaped connector(s) 520, the tactile assembly, the electronic or electromechanical switch 530/540, the manually operated switch 570, the locking mechanism, the deploying/retracting mechanism 500 of the male-shaped connector(s) 520, and each's details, each as shown in and/or described with respect to FIG. 5 may represent the same or similar power plug 160, 200, 250, and 410, housing 200, and 250, mains power socket 115, and 450, safety mechanism 165, and 300, connector(s) 215, 265, and 730, tactile assembly, electronic or electromechanical switch 220, and 270, manually operated switch 440, locking mechanism 400, deploying/retracting mechanism of the male-shaped connector(s), or each's details, respectively, as shown in and/or described with respect to FIG. 1, FIG. 2, FIG. 3, FIG. 4, FIG. 6, FIG. 7, FIG. 8, and FIG. 9, or any of the FIGS. discussed herein, and vice versa.

FIG. 6 shows a partial cross-sectional view illustration of an exemplary embodiment of a pin-based tactile assembly in accordance with one or more embodiments of the presently disclosed technology.

The partial cross-sectional view illustration of a pin-based tactile assembly mechanism 600 as depicted in FIG. 6 shows in one or more exemplary embodiments of the present technology a power plug 605, including a base 610, a deployable/retractable pin 630 affixed to a bar with an extending pin 635, together movable in direction 621, a spring 650, a movable locking element 620 movable in direction 621, having an angled surface 625. The angle between the angled surface 625 and a base surface movable locking element 620 is, for example, 40°. The pin-based tactile assembly mechanism 600 may be part of the power plug 200 as shown in and/or described with respect to FIG. 2, or any of the FIGS. discussed herein. The implementation and/or function of the movable locking element 620 may be as shown in and/or described with respect to FIG. 3, or any of the FIGS. discussed herein, for example, in an implementation comprising at least two deployable/retractable pins 630, the movable locking element 620 is assembled, and shaped to block the movement of either deployable/retractable pin 630 if such deployable/retractable pin 630 is not moved simultaneously with the other deployable/retractable pin 630, while otherwise, the simultaneous movement of the at least two deployable/retractable pins 630 is unrestricted. The elements as shown in and/or described with respect to FIG. 6 may be the same or similar elements as like elements shown in and/or described with respect to FIG. 2, and FIG. 3 or any of the FIGS. discussed herein.

FIG. 7 shows a partial cross-sectional view illustration of an exemplary embodiment of a sheath-based tactile assembly in accordance with one or more embodiments of the presently disclosed technology.

The partial cross-sectional view illustration of a sheath-based tactile assembly mechanism 700 as depicted in FIG. 7 shows in one or more exemplary embodiments of the present technology a power plug 705, including a base 710, a deployable/retractable isolation sheath 740 surrounding a male-shaped connector 730, the deployable/retractable isolation sheath 740 being affixed to a bar with an extending pin 745, together movable in direction 741, a spring 750, a movable locking element 720 movable in direction 721, having an angled surface 725. The angle between the angled surface 725 and a base surface movable locking element 720 is, for example, 40°. The sheath-based tactile assembly mechanism 700 may be part of the power plug 250 as shown in and/or described with respect to FIG. 2, or any of the FIGS. discussed herein. The implementation and/or function of the movable locking element 720 may be as shown in and/or described with respect to FIG. 3, or any of the FIGS. discussed herein, for example, in an implementation comprising at least two deployable/retractable isolation sheaths 740, the movable locking element 720 is assembled, and shaped to block the movement of either deployable/retractable isolation sheath 740 if such deployable/retractable isolation sheath 740 is not moved simultaneously with the other deployable/retractable isolation sheath 740, while otherwise, the simultaneous movement of the at least two deployable/retractable isolation sheaths 740 is unrestricted. The elements as shown in and/or described with respect to FIG. 7 may be the same or similar elements as like elements shown in and/or described with respect to FIG. 2, and FIG. 3 or any of the FIGS. discussed herein.

FIG. 8 shows a flow diagram for a plurality of method steps for operating a renewable energy source and connecting the energy source to a mains power grid in accordance with one or more embodiments of the presently disclosed technology.

The method depicted in diagram 800 can comprise: method step 810 of operating a renewable energy source, including a power inverter generating electrical AC energy, method step 820 of inserting a mains power plug connected to the energy source into a mains power wall socket connected to an electrical mains installation of a power grid, method step 830 of activating a tactile assembly detecting that the power plug is operationally inserted, method step 840 of connecting and/or operationally deploying at least one male-shaped connector of the mains power plug, method step 850 of locking the mains power plug in the mains power wall socket, and method step 860 of pushing the electrical AC energy into the mains installation of the power grid. In one or more exemplary embodiments of the present technology, a safeguard method to protect a user or a bystander from an electrical hazard includes a user inserting a power plug into a corresponding mains power socket 820, the power plug being connected to an electrical alternating current energy generator, the mains power socket being connected to a mains power installation of a residence, or a business connected to an electrical grid, and operating a safety mechanism 840/850 assembled, shaped and/or wired to protect the user or the bystander from a hazardous live contact with a male-shaped connector of the power plug when the electrical alternating current energy generator is in operation and the power plug is unplugged. The method step of operating the safety mechanism 840/850 may be correlated with the method step of a user inserting the power plug 820. The method step of operating the safety mechanism 840/850 may be performed with the method step of a user inserting the power plug 820 simultaneously. The method step of operating the safety mechanism 840/850 may be correlated with an activation of a user-operated locking mechanism 850, the locking mechanism having multiple parts, each shaped and together assembled, and geometrically arranged to lock the power plug in the mains power socket when activated, and/or vice versa. The method step of operating the safety mechanism 840/850 may be performed simultaneously with an activation of a user-operated locking mechanism 850, the locking mechanism having multiple parts, each shaped and together assembled, and geometrically arranged to lock the power plug in the mains power socket when activated, and/or vice versa. The method step of operating the safety mechanism 840/850 may be correlated with an activation of a user-operated electromechanical switch 840 assembled, shaped and wired to connect the at least one male-shaped connector of the power plug to the electrical alternating current energy generator when activated, and/or vice versa. The method step of operating the safety mechanism 840/850 may be performed simultaneously with an activation of a user-operated electromechanical switch 840 assembled, shaped and wired to connect the at least one male-shaped connector of the power plug to the electrical alternating current energy generator when activated, and/or vice versa.

FIG. 9 shows a flow diagram for a plurality of method steps for operating a renewable energy source and disconnecting the energy source from a mains power grid in accordance with one or more embodiments of the presently disclosed technology.

The method depicted in diagram 900 can comprise: method step 910 of operating a renewable energy source, including a power inverter generating electrical AC energy, method step 920 of pushing the electrical AC energy into a mains installation of a power grid via a mains power plug inserted into a mains power wall socket of the electrical mains installation, method step 930 of disconnecting and/or undeploying at least one male-shaped connector of the mains power plug, method step 940 of unlocking the mains power plug from the mains power wall socket, method step 950 of deactivating a tactile assembly detecting that the power plug is operationally inserted, and method step 960 of removing the mains power plug from the mains power wall socket.

It is to be understood that the specific order or hierarchy of operations in the methods 800 and/or 900 depicted in FIGS. 8-9 and any of the FIGS. discussed herein and throughout this disclosure are instances of example approaches and can be rearranged while remaining within the disclosed subject matter. For instance, any of the operations depicted in FIGS. 8-9 and any of the FIGS. discussed herein and throughout this disclosure can be omitted, repeated, performed in parallel, performed in a different order, and/or combined with any other of the operations depicted in FIGS. 8-9 and any of the FIGS. discussed herein and throughout this disclosure.

In yet another exemplary embodiment, an implementation, system, modus operandi and/or a method described herein, for example, as discussed with reference to and/or shown in FIG. 1, FIG. 2, FIG. 3, FIG. 4, FIG. 5, FIG. 6, FIG. 7, FIG. 8, and FIG. 9, and/or any of the FIGURES discussed herein, respectively, or as described above, may comprise one or more of the features listed in any of the preceding paragraphs, in any combination and order.

In various implementations, described process(es) may be implemented by various described system(s), such as systems or subsystems 100, 200, 250, 300, 340, 360, 380, 400, 500, 600, and 700. In addition, various described operation(s) may be added, deleted, and/or modified in implementations of the described process(es) and/or system(s). In some implementations, a described process or operations thereof may be performed in combination with other described process(es) or operations thereof.

Whenever the context requires, all words used in the singular number shall be deemed to include the plural and vice versa. Words which import one gender shall be applied to any gender wherever appropriate. Whenever the context requires, all options that are listed with the word “and” shall be deemed to include the world “or” and vice versa, and any combination thereof. If applicable, the words “vice versa” shall be deemed to include the term “the other way around.” Unless the context herein otherwise requires, the words “include”, “for example”, “by way of example”, “exempli gratia” or “e.g.” and derivative or similar terms shall be deemed in each case to be followed by the words “without limitation”.

While the present inventive concept has been described with reference to various implementations, it will be understood that these implementations are illustrative and that the scope of the present inventive concept is not limited to them. Many variations, modifications, additions, and improvements are possible. More generally, implementations in accordance with the present inventive concept have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A system to generate and distribute renewable energy, the system comprising:
a power inverter assembled and wired to generate an alternating current energy;
an electronic control unit assembled, wired, and programmed to control the power inverter to drive the alternating current energy into an electrical grid; and
a power plug shaped to conform to a mains power socket, the power plug connected to the power inverter, the power plug including:
at least one male-shaped connector conforming to at least one corresponding female-shaped connector of the mains power socket,
a housing, and
at least one contact wired to connect the power plug to the power inverter,
wherein,
the power plug comprises a safety mechanism assembled, shaped, and/or wired to protect a user or a bystander from a hazardous live contact with the at least one male-shaped connector when the system is in operation and the power plug is unplugged.

2. The system as recited in claim 1, further comprising:
one or more solar panels connected to the power inverter,
wherein,
the power inverter is an electronic power inverter operable to change direct current energy received from the one or more solar panels into the alternating current energy, and
the mains power socket is a wall power socket connected to a mains power installation of a residence or a business connected to the electrical grid.

3. The system as recited in claim 1, wherein the mains power socket and the power plug conform to one or more national, supranational, or international standards.

4. The system as recited in claim 1, wherein the safety mechanism includes an electromechanical switch assembled, shaped, and wired to disconnect the at least one male-shaped connector from a corresponding contact of the at least one contact when the power plug is unplugged.

5. The system as recited in claim 4, wherein the safety mechanism further includes a tactile assembly having multiple parts, each shaped and together assembled and geometrically arranged to detect if the power plug is unplugged.

6. The system as recited in claim 5, wherein the tactile assembly includes:
at least two tactile parts, each tactile part of the at least two tactile parts having a longitudinal extension and a longitudinal axis, each tactile part is pushed outwards of the housing mainly in a direction of its longitudinal axis by a spring, the longitudinal axis is geometrically positioned in relation to a base of the housing of the power plug mainly in line with another direction of the insertion path of the power plug into the mains power socket so that the at least two tactile parts are pushed into the housing of the power plug when the power plug is operationally positioned in the mains power socket to thereby operating the electromechanical switch to close an electrical connection between the at least one male-shaped connector with a corresponding contact of the at least one contact; and
a movable locking element assembled, shaped and geometrically arranged to prevent that only one tactile part of the at least two tactile parts can be pushed into the housing of the power plug so that the electromechanical switch is only operated to close when the at least two tactile parts are simultaneously pushed into the housing of the power plug.

7. The system as recited in claim 6, wherein at least one on the at least two tactile parts is a pin.

8. The system as recited in claim 6, wherein at least one tactile part of the at least two tactile parts is an isolation sheath covering a corresponding male-shaped connector of the at least one male-shaped connector.

9. The system as recited in claim 1, wherein the safety mechanism includes a tactile assembly having multiple parts, each shaped and together assembled and geometrically arranged to detect if the power plug is unplugged; wherein the tactile assembly includes:
at least one tactile isolation sheath, each tactile isolation sheath of the at least one two tactile isolation sheath having a longitudinal extension and a first longitudinal axis, each tactile isolation sheath is pushed outwards of the housing mainly in a direction of its first longitudinal axis by a spring, the first longitudinal axis is geometrically positioned mainly in line to a second longitudinal axis of a corresponding male-shaped connector of the at least one male-shaped connector so that the at least one tactile isolation sheath are pushed into the housing of the power plug when the power plug is operationally positioned in the mains power socket to thereby uncovering and operationally deploy the at least one male-shaped connector.

10. The system as recited in claim 9, wherein the at least one tactile isolation sheaths include at least two tactile isolation sheaths; the at least one male-shaped connectors include at least two male-shaped connectors; and the tactile assembly further includes:
a movable locking element assembled, shaped and geometrically arranged to prevent that only one tactile isolation sheath of the at least two tactile isolation sheaths can be pushed into the housing of the power plug so that the at least two male-shaped connectors are only uncovered and operationally deployed when the at least two tactile isolation sheaths are simultaneously pushed into the housing of the power plug.

11. The system as recited in claim 1, wherein the safety mechanism is user-operated requiring a key.

12. The system as recited in claim 1, wherein the safety mechanism includes a user-operated locking mechanism having multiple parts, each shaped and together assembled and geometrically arranged to lock the power plug in the mains power socket.

13. The system as recited in claim 12, wherein the safety mechanism further includes an electromechanical switch assembled, shaped, and wired to disconnect or connect the at least one male-shaped connector from or with a corresponding contact of the at least one contacts; wherein
the user-operated locking mechanism is further shaped and arranged to operate the electromechanical switch so that an electrical connection between the at least one male-shaped connector with a corresponding contact of the at least one contacts is closed when the locking mechanism is activated by a user.

14. The system as recited in claim 13, wherein the safety mechanism further includes a tactile assembly having multiple parts, each shaped and together assembled and geometrically arranged to detect if the power plug is unplugged; the tactile assembly being further shaped and arranged to block the user-operated locking mechanism when the power plug is unplugged.

15. The system as recited in claim 1, wherein the at least one male-shaped connectors is retraced and at least partially concealed inside the housing when the power plug is deactivated; the at least one male-shaped connector is forwarded and thereby operationally deployed when the power plug is activated; and wherein the safety mechanism includes a user-operated forwarding mechanism assembled, shaped and geometrically arranged to deploy or to retract the at least one male-shaped connectors to thereby activate or deactivate the power plug.

16. A power plug comprising:
at least one male-shaped connector conforming to at least one corresponding female-shaped connector of a mains power socket;
a housing; and
at least one contact wired to connect the power plug to an electrical alternating current energy generator,
wherein,
the power plug comprises a safety mechanism assembled, shaped, and/or wired to protect a user or a bystander from a hazardous live contact with the at least one male-shaped connector when the electrical alternating current energy generator is in operation and the power plug is unplugged.

17. A safeguard method to protect a user or a bystander from an electrical hazard, the method comprising:
inserting a power plug into a corresponding mains power socket, the power plug being connected to an electrical alternating current energy generator, the mains power socket being connected to a mains power installation of a residence, or a business connected to an electrical grid; and
operating a safety mechanism assembled, shaped, and/or wired to protect the user or the bystander from a hazardous live contact with at least one male-shaped connector of the power plug when the electrical alternating current energy generator is in operation and the power plug is unplugged.

18. The method as recited in claim 17, wherein the operating of the safety mechanism is correlated with the method step of a user inserting the power plug.

19. The method as recited in claim 17, wherein the operating of the safety mechanism is correlated with an activation of a user-operated locking mechanism, the locking mechanism having multiple parts, each shaped and together assembled, and geometrically arranged to lock the power plug in the mains power socket when activated.

20. The method as recited in claim 17, wherein the operating of the safety mechanism is correlated with an activation of a user-operated electromechanical switch assembled, shaped, and wired to connect the at least one male-shaped connector of the power plug to the electrical alternating current energy generator when activated.
